(19) United States
(12) Patent Application Publication
(10) Pub. No.: US 2015/0050576 A1
(43) Pub. Date: Feb. 19, 2015

(54) FUEL CELL SYSTEM AND METHOD OF CONTROLLING CONCENTRATION OF FUEL

(71) Applicant: SAMSUNG ELECTRONICS CO., LTD., Suwon-si (KR)

(72) Inventors: Young-jae KIM, Seoul (KR); Joon-hee KIM, Seoul (KR); Dae-jong YOO, Hwaseong-si (KR)

(21) Appl. No.: 14/461,909

(22) Filed: Aug. 18, 2014

(30) Foreign Application Priority Data
Aug. 19, 2013 (KR) 10-2013-0098133

(51) Int. Cl. H01M 8/04

(52) U.S. Cl. CPC H01M 8/04798; H01M 8/04447; H01M 8/04708; H01M 8/04365
USPC 429/440; 429/433; 429/444

(57) ABSTRACT

A method of controlling a concentration of a fuel to be supplied to a stack of a fuel cell system, the method including determining a reference concentration of the fuel to be supplied to the stack when the stack is in a normal mode, monitoring temperature of the stack, and controlling the concentration of the fuel to be supplied to the stack, based on a result of the monitoring the temperature of the stack.

### CROSS-REFERENCE TO RELATED APPLICATIONS

This application claims priority to Korean Patent Application No. 10-2013-0098133, filed on Aug. 19, 2013, and all the benefits accruing therefrom under 35 U.S.C. §119, the content of which in its entirety is herein incorporated by reference.

### BACKGROUND

1. Field

The disclosure relates to fuel cell systems and methods of improving the performance of a fuel cell by controlling the concentration of fuel.

2. Description of the Related Art

A fuel cell is an eco-friendly alternative energy technology of generating energy from materials such as hydrogen which are abundantly present on the earth and more attention has been paid thereto. In general, a fuel cell includes a stack, in which a plurality of cells configured to generate unit power, are combined. The stack generates power from fuel supplied thereto. In general, the longer a driving duration of a fuel cell system, the less the power output from the stack due to a change in driving conditions and a methanol crossover. Accordingly, research has been actively conducted into methods of suppressing a decrease in the amount of power.

### SUMMARY

Provided are embodiments of fuel cell systems and methods of improving the performance of a full cell by using a method of controlling the concentration of fuel.

Additional aspects will be set forth in part in the description which follows and, in part, will be apparent from the description, or may be learned by practice of the presented embodiments.

According to an embodiment of the invention, a method of controlling an operation of a fuel cell system includes determining a reference concentration of a fuel to be supplied to a stack of the fuel cell system when the stack is in a normal mode; monitoring a temperature of the stack; and controlling a concentration of the fuel to be supplied to the stack, based on a result of the monitoring the temperature.

According to another embodiment of the invention, a method of controlling a concentration of a fuel to be supplied to a stack of a fuel cell system includes determining a reference concentration of the fuel to be supplied to the stack when the stack is in a normal mode; and controlling the concentration of the fuel to be supplied to the stack such that the concentration periodically increases or decreases based on the reference concentration.

According to embodiments of the invention, a fuel cell system includes a fuel storage which stores a fuel; a fuel pump which discharges the fuel stored in the fuel storage; a stack which generates electrical energy from the fuel discharged from the fuel pump; and a controller which monitors a temperature of the stack, and controls a concentration of fuel to be supplied to the stack based on a result of monitoring the temperature of the stack.

### BRIEF DESCRIPTION OF THE DRAWINGS

These and/or other features of embodiments of the invention will become apparent and more readily appreciated from the following description of the embodiments, taken in conjunction with the accompanying drawings of which:

FIG. 1 is a block diagram showing an embodiment of a fuel cell system, according to the invention;

FIG. 2 is a block diagram showing another embodiment of a fuel cell system, according to the invention;

FIG. 3 is a flowchart showing an embodiment of a method of controlling an operation of a fuel cell system, according to the invention;

FIG. 4 is a flowchart showing an embodiment of a method of controlling the concentration of fuel, according to the invention;

FIG. 5 is a flowchart showing another embodiment of a method of controlling the concentration of fuel, according to the invention; and

FIG. 6 is a diagram illustrating embodiments of a method of controlling an operation of a fuel pump based on a change in the amount of power, according to the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the invention are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in detail with reference to the accompanying drawings.

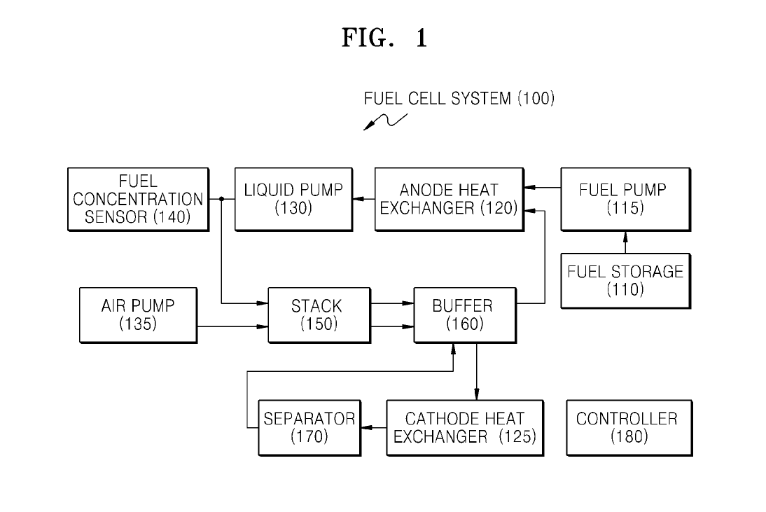

FIG. 1 is a block diagram showing an embodiment of a fuel cell system 100, according to the invention. Referring to FIG. 1, an embodiment of the fuel cell system 100 includes a fuel storage 110, a fuel pump 115, an anode heat exchanger 120, a liquid pump 130, a fuel concentration sensor 140, a stack 150, an air pump 135, a buffer 160, a cathode heat exchanger 125, a separator 170 and a controller 180.

The fuel storage 110 stores fuel therein. In one embodiment, for example, the fuel may be liquid fuel such as methanol or ethanol.

The fuel stored in the fuel storage 110 is discharged via the fuel pump 115. The fuel pump 115 is controlled by the controller 180.

The anode heat exchanger 120 performs heat exchange and mixes fuels therein. Water or fuel discharged from an anode of the stack 150 is supplied to the anode heat exchanger 120. Herein, the fuel discharged from the anode of the stack 150 means fuel that remains after the fuel reacts in the stack 150. The water discharged from the stack 150 means a byproduct generated after the fuel reacts in the stack 150. The fuel discharged from the fuel pump 115 is supplied to the anode heat exchanger 120. Thus, the fuel discharged from the stack 150 and the fuel discharged from the fuel pump 115 are mixed in the anode heat exchanger 120. In general, the concentration of the fuel discharged from the stack 150 is lower than the concentration of the fuel discharged from the fuel pump 115.

The anode heat exchanger 120 absorbs the heat of the fuel and the water or supplies heat to the fuel and the water. A device that includes a thermal medium (not shown) may be connected outside the anode heat exchanger 120.

The liquid pump 130 supplies the fuel from the anode heat exchanger 120 to the stack 150.

The fuel concentration sensor 140 measures the concentration of the fuel supplied to the stack 150.

The air pump 135 supplies air to the stack 150.

The stack 150 generates power from the fuel and the air supplied thereto.

The buffer 160 separates byproducts discharged from the stack 150. In one embodiment, for example, byproducts, such as fuel, water, vapor and carbon dioxide, may be discharged from the stack 150. The buffer 160 discharges fuel and water to the anode heat exchanger 120, and discharges carbon dioxide and vapor to the cathode heat exchanger 125. In an embodiment, the buffer 160 may not include a separation device, and the buffer 160 may separate a liquid and a gas from each other by connecting a pipe connected to the anode heat exchanger 120 to a lower portion of the buffer 160 and a pipe connected to the cathode heat exchanger 125 to an upper portion of the buffer 160. In such an embodiment, the fuel and the water are in a liquid state and are thus discharged to the anode heat exchanger 120 via the pipe connected to the lower portion of the buffer 160. In such an embodiment, the carbon dioxide and the vapor are discharged to the cathode heat exchanger 125 via the pipe connected to the upper portion of the buffer 160.

The cathode heat exchanger 125 absorbs heat of the carbon dioxide and the vapor. A device that includes a thermal medium (not shown) may be connected outside the cathode heat exchanger 125.

The separator 170 separates the carbon dioxide and the water from each other. The separator 170 discharges the separated water back to the buffer 160 and the separated carbon dioxide to the outside of the fuel cell system 100.

The controller 180 controls the elements of the fuel cell system 100. In an embodiment, the controller 180 may control the concentration of fuel to be supplied to the stack 150 by controlling an operation of the fuel pump 115.

The controller 180 controls the concentration of fuel to be supplied to the stack 150 based on a change in the amount of power output from the stack 150 or a change in the temperature of the stack 150. When the stack 150 operates in a normal mode for a predetermined time, the amount of the power output from the stack 150 decreases or the temperature of the stack 150 increases. The controller 180 measures the decrease in the amount of the power output from the stack 150 or the increase in the temperature of the stack 150, and controls the concentration of fuel to be supplied to the stack 150 based on a result of the measurement.

In an embodiment, when the decrease in the amount of the power output from the stack 150 or the increase in the temperature of the stack 150 is great, the controller 180 controls the fuel cell system 100 to lower the concentration of the fuel to be supplied to the stack 150. In one embodiment, for example, the controller 180 may increase a time period during which the fuel pump 115 is in a turned-off state or reduce a time period during which the fuel pump 115 is in a turned-on state to lower the concentration of the fuel to be supplied to the stack 150.

In an embodiment, methanol is supplied in a liquid or gaseous state based on reaction conditions. A most part of the methanol is easily used to perform oxidation in an anode but a part of the methanol in the liquid state may move through a membrane (film) used as an electrolyte and is thus directly oxidized. This phenomenon is called a methanol crossover, and the performance of fuel cells may be degraded due to the methanol crossover. If a methanol aqueous solution of a constant concentration is supplied to the stack 150 when the fuel cell system 100 is in the normal mode, the amount of the methanol crossover becomes accumulated as time goes by, thereby degrading the performance of the stack 150 including the fuel cells.

The normal mode means a state in which the elements of the fuel cell system 100 operate normally after an initial operation of the elements. The initial operation means a process of preparing the elements of the fuel cell system 100 to operate normally. In one embodiment, for example, the initial operation may include increasing the temperature of the stack 150 to operation temperature or increasing or reducing the concentration of the methanol aqueous solution to be supplied to the anode of the stack 150 to a reference concentration.

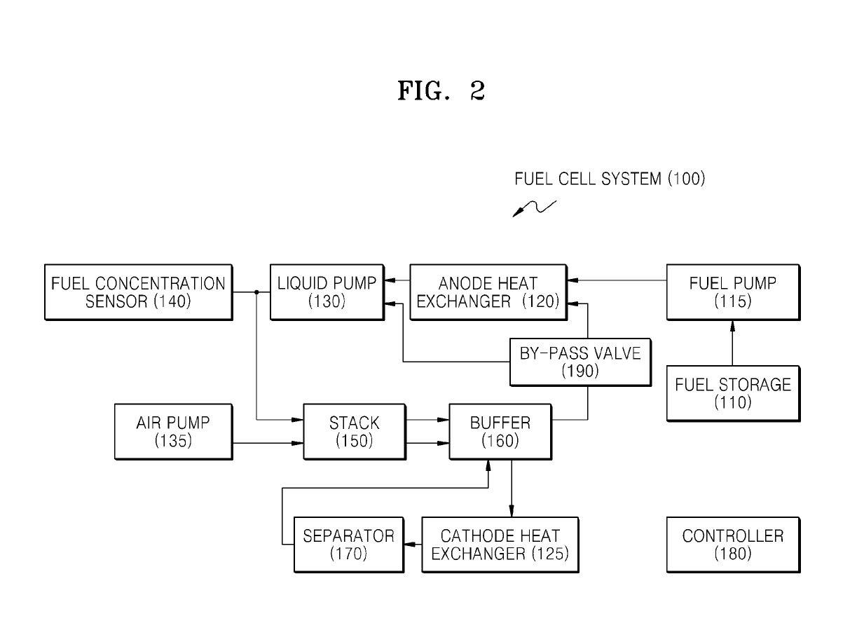

Hereinafter, embodiments of a method of periodically controlling the concentration of fuel by the controller 180 will be described in detail with reference to FIGS. 2 to 8.

FIG. 2 is a block diagram showing another embodiment of a fuel cell system 100, according to the invention. The fuel cell system shown in FIG. 2 is substantially the same as the fuel cell system illustrated in FIG. 1 except for a by-pass valve. The same or like elements shown in FIG. 2 have been labeled with the same reference characters as used above to describe the exemplary embodiments of the fuel cell system shown in FIG. 1, and any repetitive detailed description thereof will hereinafter be omitted or simplified.

Referring to FIG. 2, an embodiment of the fuel cell system 100 may further include a by-pass valve 190. The by-pass valve 190 controls supply of fuel and water output from a buffer 160 or a stack 150. In such an embodiment, the by-pass valve 190 may discharge the fuel and the water output from the buffer 160 or the stack 150 to an anode heat exchanger 120 or a liquid pump 130. In such an embodiment, the by-pass valve 190 may effectively prevent fuel discharged from a fuel pump 115 from being supplied into the anode heat exchanger 120. The by-pass valve 190 may be controlled by a controller 180.

Although not shown in FIGS. 1 and 2, the fuel cell system 100 may further include a plurality of sensors. In one embodiment, for example, the fuel cell system 100 may include a sensor for measuring the temperature of the stack 150 or a sensor for measuring the concentration of fuel output from the stack 150. Although not shown, the fuel cell system 100 may further include a device for measuring the amount of power output from the stack 150.

The controller 180 controls the concentration of fuel to be supplied to the stack 150 based on data measured using the plurality of sensors. The controller 180 may control the fuel pump 115 or the by-pass valve 190 to control the concentration of the fuel. In one embodiment, for example, when the intensity of power output from the stack 150 is less than a threshold, the controller 180 may output a control signal to the by-pass valve 190 to lower the concentration of the fuel. When the concentration of fuel supplied via the by-pass valve 190 is lower than the concentration of fuel stored in a fuel storage 110, the controller 180 controls the by-pass valve 190 to block the fuel discharged from the fuel pump 115 and to supply the fuel to the anode heat exchanger 120 or the liquid pump 130. Accordingly, fuel of a low concentration may be supplied to the stack 150 via the liquid pump 130.

In an alternative embodiment, the controller 180 controls the concentration of fuels mixed in the anode heat exchanger 120 by controlling the amount of fuel to be discharged from the fuel pump 115. In such an embodiment, the controller 180 controls the by-pass valve 190 and the fuel pump 115 to mix fuels to be supplied to the anode heat exchanger 120 from the by-pass valve 190 and the fuel pump 115. The controller 180 may adaptively control the by-pass valve 190 and the fuel pump 115, based on a change in the amount of power output from the stack 150 or a change in the temperature of the stack 150.

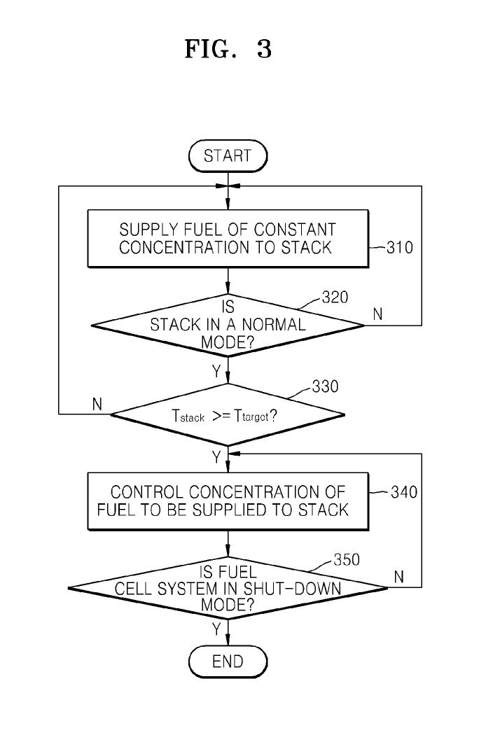

FIG. 3 is a flowchart showing an embodiment of a method of controlling an operation of a fuel cell system, according to the invention. Referring to FIG. 3, the method of controlling the concentration of fuel includes operations to be sequentially performed by the fuel cell system 100 of FIG. 1 or 2. Thus, any repetitive description of the operations of the fuel cell system 100 described with reference to FIG. 1 or 2 will hereinafter be omitted. Hereinafter, an embodiment of the method of controlling the concentration of fuel by the fuel cell system 100 will be described in detail.

In an embodiment, the fuel cell system 100 supplies fuel of a constant concentration to the stack 150 (operation 310). The concentration of the fuel may be predetermined based on the type and characteristics of the fuel cell system 100.

In an embodiment, the controller 180 determines whether the stack 150 is in the normal mode (operation 320). The method proceeds to operation 330 when it is determined that the stack 150 is in the normal mode, and proceeds to operation 310 it is determined that the stack 150 is not in the normal mode. Herein, the concentration of the fuel supplied to the stack 150 in the normal mode may be referred to as a reference concentration. Whether the stack 150 is in the normal mode may be determined by the amount of the fuel supplied to the stack 150 or the temperature of the stack 150. In general, an operation following an initial operation is considered as the normal mode, and the initial operation includes operations of increasing the temperature of the stack 150 to a predetermined temperatures or a desired temperature.

In an embodiment, the controller 180 determines whether the temperature T_{stack} of the stack 150 is greater than a target temperature T_{target} (operation 330). The method proceeds to operation 340 when the temperature T_{stack} of the stack 150 is greater than the target temperature T_{target}, and proceeds to operation 310 when the temperature T_{stack} of the stack 150 is not greater than the target temperature T_{target}.

In an embodiment, the concentration of the fuel to be supplied to the stack 150 is controlled, e.g., by the controller 180 (operation 340). The efficiency of the stack 150 is degraded when the temperature T_{stack} of the stack 150 is greater than the target temperature T_{target}. Thus, the controller 180 may increase the efficiency of the stack 150 by controlling the concentration of the fuel to be supplied to the stack 150. In such an embodiment, when the temperature T_{stack} of the stack 150 is greater than the target temperature T_{target}, the controller 180 may increase the efficiency of the stack 150 by controlling the concentration of the fuel supplied to the stack 150.

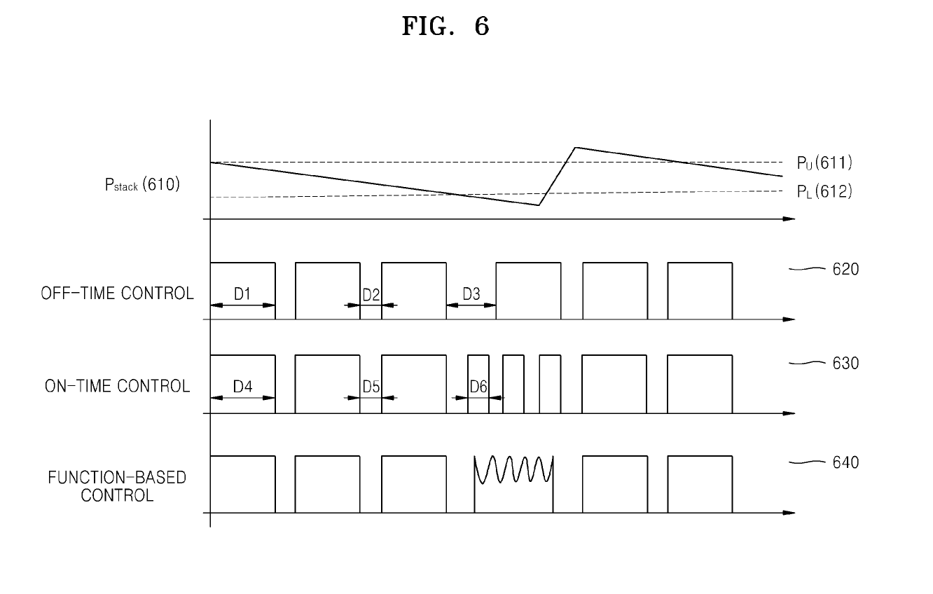

The controller 180 may control the concentration of the fuel to be supplied to the stack 150, based on a result of monitoring the amount of power output from the stack 150 or the concentration of fuel discharged from the stack 150. In one embodiment, for example, the controller 180 may lower the concentration of the fuel to be substantially proportional to a change in the amount of power output from the stack 150, which will be described later in detail with reference to FIGS. 6 and 7.

In an embodiment, the controller 180 may periodically increase or decrease the concentration of fuel to be supplied to the stack 150. In one embodiment, for example, after the controller 180 operates in the normal mode, the controller 180 may control the fuel pump 115 in the form of a periodic function such as a sine wave. In such an embodiment, the controller 180 may control the amount of fuel discharged from the fuel pump 115 in the form of the periodic function. In such an embodiment, the controller 180 may decrease the amount of fuel to be discharged from the fuel pump 115 at predetermined time intervals.

In an embodiment, the controller 180 determines whether the fuel cell system 100 is in a shut-down mode (operation 350). The operation of the fuel cell system 100 is stopped when it is determined that the fuel cell system 100 is in the shut-down mode, and the method proceeds to operation 340 when it is determined that the fuel cell system 100 is not in the shut-down mode. When it is determined that the fuel cell system 100 is not in the shut-down mode, the controller 180 continuously controls the concentration of fuel to be supplied to the stack 150. The shut-down mode may be a mode in which the operation of the fuel cell system 100 is to be stopped.

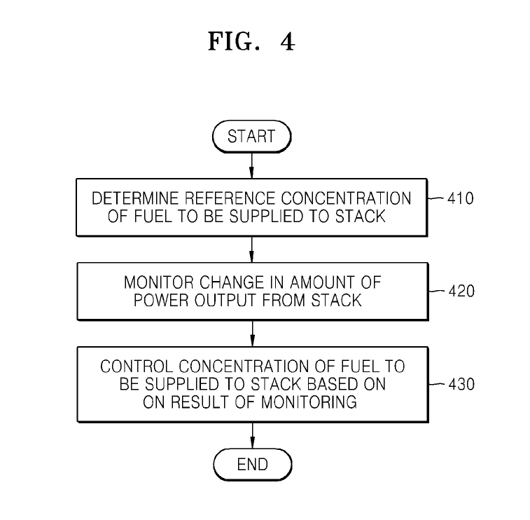

FIG. 4 is a flowchart showing an embodiment of a method of controlling the concentration of fuel, according to the invention. Referring to FIG. 1 or 2 and 4, in an embodiment, the fuel cell system 100 determines reference concentration of fuel to be supplied to the stack 150 (operation 410). When the fuel cell system 100 is in the normal mode, fuel of the reference concentration is supplied to the stack 150. In an embodiment, the fuel cell system 100 may initially set the reference concentration as a predetermined value and change the reference concentration based on other conditions. In such an embodiment, in the normal mode, the fuel cell system 100 may measure the concentration of fuel that is actually supplied to the stack 150 and set the measured concentration as the reference concentration.

In an embodiment, a change in the amount of power output from the stack 150 is monitored, e.g., by the controller 180 (operation 420). The controller 180 may monitor whether the amount of the power output from the stack 150 decreases, and whether the decrease in the amount of the output power is greater than a threshold. The threshold may be set as a predetermined value and stored in the controller 180 and may be variously set based on the type of the fuel cell system 100. The controller 180 may calculate the decrease in the amount of the output power by calculating the difference between the threshold and the amount of power output in real time. In such an embodiment, the controller 180 may monitor whether the amount of the power output from the stack 150 exceeds a preset lower or upper limit.

In an embodiment, the controller 180 controls the concentration of the fuel to be supplied to the stack 150 based on a result of the monitoring (operation 430). In one embodiment, for example, when the result of the monitoring indicates that the change in the amount of the output power exceeds the lower limit, the controller 180 controls the fuel pump 115 to lower the concentration of the fuel to be supplied to the stack 150. When the result of the monitoring indicates that the change in the amount of the output power exceeds the upper limit, the controller 180 controls the fuel pump 115 to adjust the concentration of the fuel to be supplied to the stack 150 to the reference concentration.

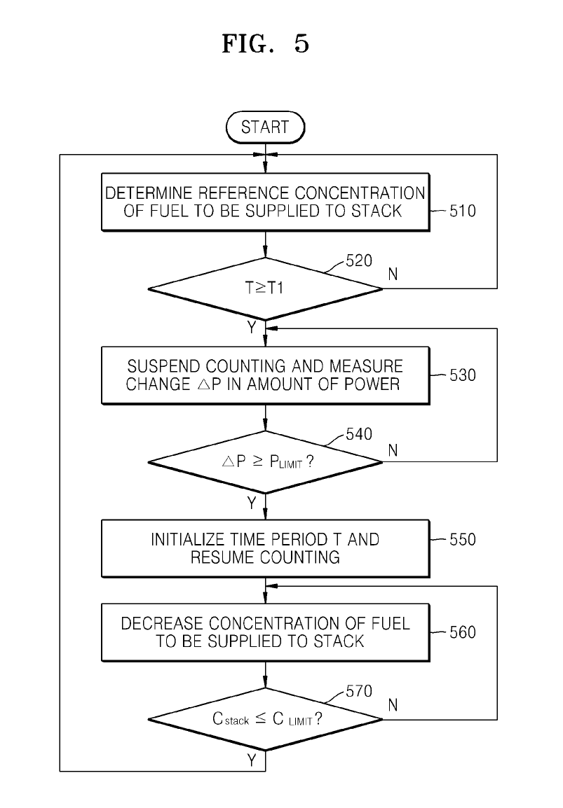

FIG. 5 is a flowchart showing another embodiment of a method of controlling the concentration of fuel, according to the invention. Referring to FIG. 1 or 2 and 5, in an embodiment, the fuel cell system 100 determines a reference concentration of fuel to be supplied to the stack 150 (operation 510).

In an embodiment, the controller 180 determines whether a time period T that the fuel cell system 100 operates in the normal mode is equal to or greater than a preset time period T1 (operation 520). The method proceeds to operation 520 when the time period T is greater than the time period T1 and proceeds to operation 510 when the time period T is not greater than the time period T1. The controller 180 counts a time after the fuel cell system 100 operates in the normal mode. The time period T1 may be preset based on the type of the fuel cell system 100 and stored in a memory (not shown). In an embodiment, the time period T1 may be preset by experimenting characteristics of the fuel cell system 100. In one embodiment, for example, a time period between a point of time that the fuel cell system 100 operates in the normal mode and a point of time that the efficiency of the fuel cell system 100 decreases may be measured and set as the preset time period T1.

In an embodiment, the controller 180 stops the counting and measures a change ΔP in the amount of power output from the stack 150 (operation 530).

In an embodiment, the controller 180 determines whether the measured change ΔP is equal to or greater than a power value P_{LIMIT} (operation 540). The method proceeds to operation 550 when the measured change ΔP is equal to or greater than the power value P_{LIMIT} and proceeds to operation 530 when the measured change ΔP is not equal to or greater than the power value P_{LIMIT}. The power value P_{LIMIT} may be set as a predetermined value.

In an embodiment, the controller 180 initializes the time period T and resumes the counting (operation 550).

In an embodiment, the controller 180 controls the fuel pump 115 or the by-pass valve 190 to decrease the concentration of the fuel to be supplied to the stack 150 (operation 560).

In an embodiment, the controller 180 determines whether the concentration C_{stack} of the fuel to be supplied to the stack 150 is less than or equal to a preset concentration C_{LIMIT} (operation 570). The method proceeds to operation 510 when the concentration C_{stack} is less than or equal to the preset concentration C_{LIMIT} and proceeds to operation 560 when the concentration C_{stack} is not less than or equal to the preset concentration C_{LIMIT}.

FIG. 6 is a diagram illustrating embodiments of a method of controlling an operation of a fuel pump based on a change in the amount of power, according to the invention. In FIG. 6, the graph 610 shows a variation in the amount of power P_{stack} output from the stack 150 according to time, graphs 620 to 640 show turned-on and turned-off states of the fuel pump 115 according to time. In the graph 610, ‘P_{U}’ and ‘P_{L}’ denote an upper limit and a lower limit, respectively. The controller 180 monitors whether the amount of power P_{stack} is less than the upper limit P_{U} or is greater than the lower limit P_{L}.

The graph 620 shows a process of controlling an ‘on’/‘off’ time of the fuel pump 115 by the controller 180. Referring to the graph 620, in an embodiment, the controller 180 may maintain an ‘on’ time of the fuel pump 115 at a substantially constant level D₁ but increase an ‘off’ time of the fuel pump 115. In such an embodiment, while the amount of power P_{stack} is between the upper limit P_{U} and the lower limit P_{L}, the controller 180 maintains an ‘off’ time of the fuel pump 115 at a first level D₂. However, when the amount of power P_{stack} is lower than the lower limit P_{L}, the controller 180 increases the ‘off’ time of the fuel pump 115 from the first level D₂ to a second level D₃.

The graph 630 shows a process of controlling an ‘on’ time of the fuel pump 115 by the controller 180. Referring to the graph 630, in another embodiment, the controller 180 may maintain an ‘off’ time of the fuel pump 115 at a substantially constant level D₅ but decrease an ‘on’ time of the fuel pump 115. In such an embodiment, while the amount of power P_{stack} is between the upper limit P_{U} and the lower limit P_{L}, the controller 180 maintain the ‘on’ time of the fuel pump 115 at a first level D₄. However, when the amount of power P_{stack} is less than the lower limit P_{L}, the controller 180 reduces the ‘on’ time of the fuel pump 115 from the first level D₄ to a second level D₆.

The graph 640 shows a process of controlling the fuel pump 115 by the controller 180 based on a periodic function. Referring to the graph 640, in another embodiment, the controller 180 may maintain an ‘on’ time and an ‘off’ time of the fuel pump 115 at a substantially constant level but may control an operation of the fuel pump 115 based on the periodic function while the fuel pump 115 is ‘on’. In such an embodiment, when the amount of power P_{stack} is less than the lower limit P_{L}, the controller 180 controls the fuel pump 115 such that the amount of fuel discharged from the fuel pump 115 repeatedly increases and decrease while the fuel pump 115 is ‘on’.

As described above, according to one or more embodiments of the invention, the concentration of fuel to be supplied to a stack may be controlled based on a change in the temperature of the stack.

In an embodiment, the concentration of fuel to be supplied to the stack may be controlled based on a change in the amount of power output from the stack.

In an embodiment, the concentration of fuel to be supplied to the stack may be controlled by controlling an ‘on’/‘off’ time of a fuel pump.

In an embodiment, the concentration of fuel to be supplied to the stack may be controlled by periodically controlling the fuel pump.

In an embodiment, the performance of a fuel cell may be restored periodically by periodically controlling the fuel pump to adjust the concentration of fuel to be supplied to the stack to reference concentration or lower concentration so as to control the methanol crossover.

Other embodiments of the invention can also be implemented through computer readable code/instructions in/on a medium, e.g., a computer readable medium, to control at least one processing element to implement any embodiment described herein. The medium may correspond to any medium/media permitting the storage and/or transmission of the computer readable code.

The computer readable code may be recorded or transferred on a medium in a variety of ways, and the medium may include recording media, such as magnetic storage media, e.g., read-only memory (“ROM”), floppy disks or hard disks, and optical recording media, e.g., compact disk-read-only memory (CD-ROM), or a digital versatile disk (“DVD”), and transmission media such as Internet transmission media. Thus, the medium may be such a defined and measurable structure including or carrying a signal or information, such as a device carrying a bitstream according to one or more embodiments of the invention. The media may also be a distributed network, such that the computer readable code is stored/transferred and executed in a distributed fashion. Furthermore, the processing element may include a processor or a computer processor, and processing elements may be distributed and/or included in a single device.

It should be understood that the embodiments described therein should be considered in a descriptive sense only and not for purposes of limitation. Descriptions of features or aspects within each embodiment should typically be considered as available for other similar features or aspects in other embodiments.

What is claimed is:

1. A method of controlling an operation of a fuel cell system, the method comprising:
determining a reference concentration of a fuel to be supplied to a stack of the fuel cell system when the stack is in a normal mode;
monitoring a temperature of the stack; and
controlling a concentration of the fuel to be supplied to the stack, based on a result of the monitoring the temperature of the stack.

2. The method of claim 1, wherein
the monitoring the temperature of the stack comprises monitoring whether the temperature of the stack is greater than a preset target temperature, and
the controlling the concentration of the fuel comprises measuring a decrease in an amount of power output from the stack and controlling the concentration of the fuel to be substantially proportional to the decrease in the amount of the power, when the temperature of the stack is higher than the preset target temperature.

3. The method of claim 1, wherein the controlling the concentration of the fuel comprises periodically decreasing the concentration of the fuel.

4. The method of claim 1, wherein the controlling the concentration of the fuel comprises controlling the concentration of the fuel, based on a change in concentration of fuel discharged from the stack or a change in the temperature of the stack.

5. The method of claim 1, wherein the controlling the concentration of the fuel comprises controlling the concentration of the fuel to increase or decrease based on a periodic function.

6. The method of claim 5, wherein the periodic function is substantially in the form of a sine function.

7. The method of claim 5, wherein the concentration of the fuel to be supplied to the stack, which is controlled to increase or decrease based to the periodic function, is lower than the reference concentration.

8. A method of controlling a concentration of a fuel to be supplied to a stack of a fuel cell system, the method comprising:
determining a reference concentration of the fuel to be supplied to the stack when the stack is in a normal mode; and
controlling the concentration of the fuel to be supplied to the stack such that the concentration of the fuel periodically increases or decreases based on the reference concentration.

9. A fuel cell system comprising:
a fuel storage which stores a fuel;
a fuel pump which discharges the fuel stored in the fuel storage;
a stack which generates electrical energy from the fuel discharged from the fuel pump; and
a controller which monitors a temperature of the stack, and controls a concentration of the fuel to be supplied to the stack based on a result of monitoring the temperature of the stack.

10. The fuel cell system of claim 9, wherein the controller controls the concentration of the fuel to be supplied to the stack by controlling an on-time and an off-time of the fuel pump such that the on-time of the fuel pump is maintained at a substantially constant level and the off-time of the fuel pump is adjusted.

11. The fuel cell system of claim 10, wherein the controller measures a decrease in an amount of power output from the stack and adjusts the off-time of the fuel pump to be substantially proportional to the decrease in the amount of the power.

12. The fuel cell system of claim 10, wherein the controller periodically increases the off-time of the fuel pump.

13. The fuel cell system of claim 9, wherein the controller monitors a change in concentration of the fuel discharged from the stack or a change in an amount of power output from the stack.

14. The fuel cell system of claim 9, wherein the controller controls the fuel pump such that an amount of the fuel discharged from the fuel pump increases or decreases based on a periodic function.

15. The fuel cell system of claim 14, wherein the periodic function is substantially in the form of a sine function.

16. The fuel cell system of claim 14, wherein the concentration of the fuel to be supplied to the stack, which increases or decreases based on the periodic function, is lower than about a reference concentration of the fuel to be supplied to the stack when the stack is in a normal mode.

17. The fuel cell system of claim 9, further comprising:
an anode heat exchanger in which fuel discharged from the stack and the fuel discharged from the fuel pump are mixed; and
a by-pass valve disposed between the stack and the anode heat exchanger and configured to adjust amounts of fuels discharged from the stack and the fuel pump.

18. The fuel cell system of claim 17, wherein the controller controls the by-pass valve to block the fuel discharged from the fuel pump.
